(19) United States
(12) Patent Application Publication
(10) Pub. No.: US 2015/0360920 A1
(43) Pub. Date: Dec. 17, 2015

(54) Mechanical Lifting Assembly

(71) Applicant: Tony Frazier, Goshen, AL (US)

(72) Inventor: Tony Frazier, Goshen, AL (US)

(21) Appl. No.: 14/303,710

(22) Filed: Jun. 13, 2014

(51) Int. Cl. B66C 23/44; B66F 9/075; A01B 59/06; B66F 9/06

(52) U.S. Cl. CPC B66C 23/44; B66F 9/06; B66F 9/075; A01B 59/066

(57) ABSTRACT

A mechanical lifting assembly for being coupled to a vehicle such that said lifting assembly is extendable rearwardly from the vehicle includes a mount coupled to a vehicle. A swing arm is movably coupled to the mount. The swing arm extends rearwardly from the vehicle. The swing arm is positionable at a selected angle with respect to the mount. A piston is coupled between the mount and the swing arm. The piston urges the swing arm to position the swing arm at the selected angle with respect to the mount. A jaw is coupled to a distal end of the swing arm with respect to the mount. The jaw engaeges an object. The object is movable when the piston urges the swing arm.

### BACKGROUND OF THE DISCLOSURE

### Field of the Disclosure

The disclosure relates to lifting devices and more particularly pertains to a new lifting device for being coupled to a vehicle such that the lifting assembly is extendable rearwardly from the vehicle.

### SUMMARY OF THE DISCLOSURE

An embodiment of the disclosure meets the needs presented above by generally comprising a mount coupled to a vehicle. A swing arm is movably coupled to the mount. The swing arm extends rearwardly from the vehicle. The swing arm is positionable at a selected angle with respect to the mount. A piston is coupled between the mount and the swing arm. The piston urges the swing arm to position the swing arm at the selected angle with respect to the mount. A jaw is coupled to a distal end of the swing arm with respect to the mount. The jaw engaeges an object. The object is movable when the piston urges the swing arm.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a mechanical lifting assembly according to an embodiment of the disclosure.

FIG. 2 is a right side view of an embodiment of the disclosure.

FIG. 3 is a top view of an embodiment of the disclosure.

FIG. 4 is a back view of an embodiment of the disclosure.

FIG. 5 is an in-use view of an embodiment of the disclosure.

FIG. 6 is a perspective view of an alternative embodiment of the disclosure.

FIG. 7 is a top view of an alternative embodiment of the disclosure.

### DESCRIPTION OF THE PREFERRED EMBODIMENT

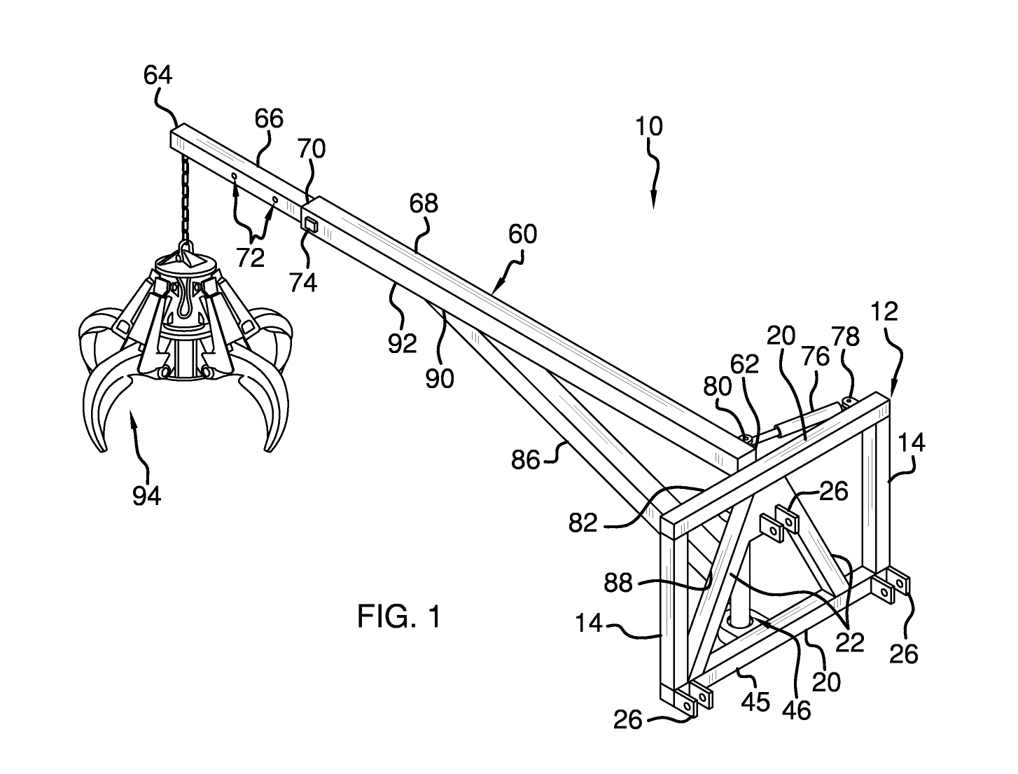

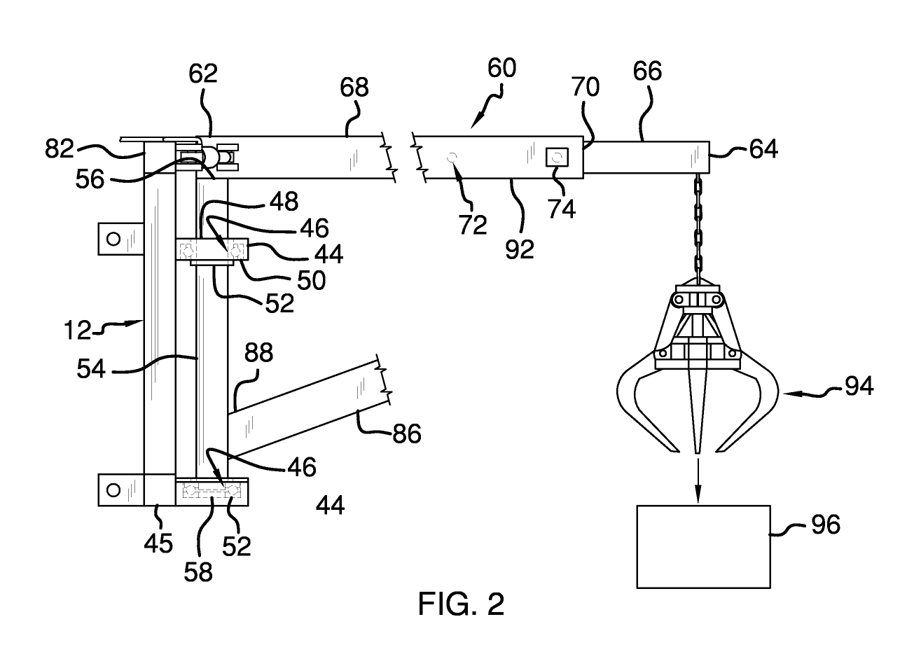

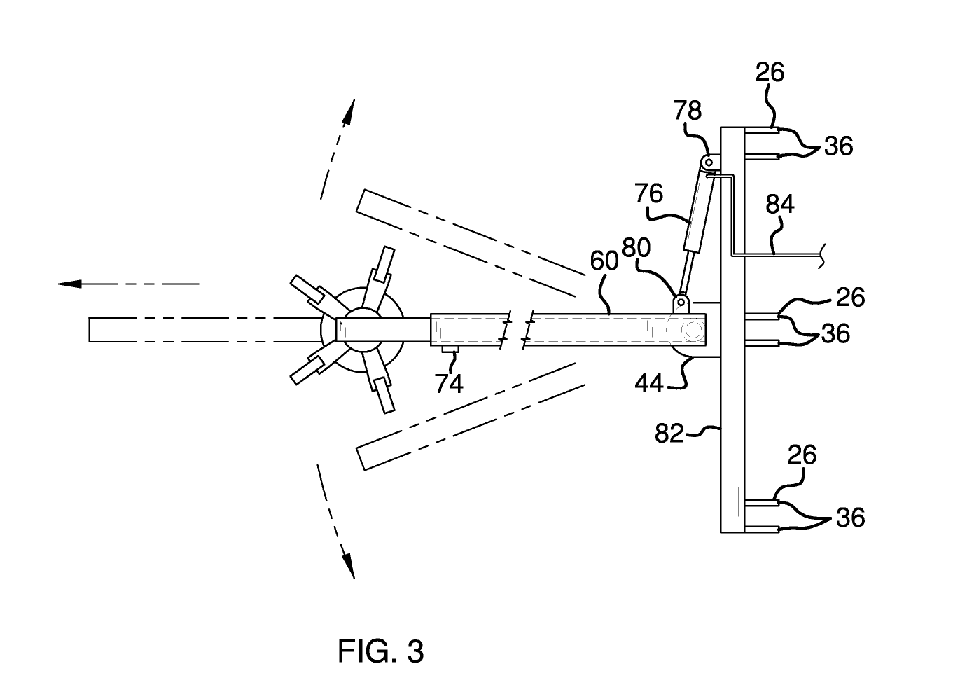

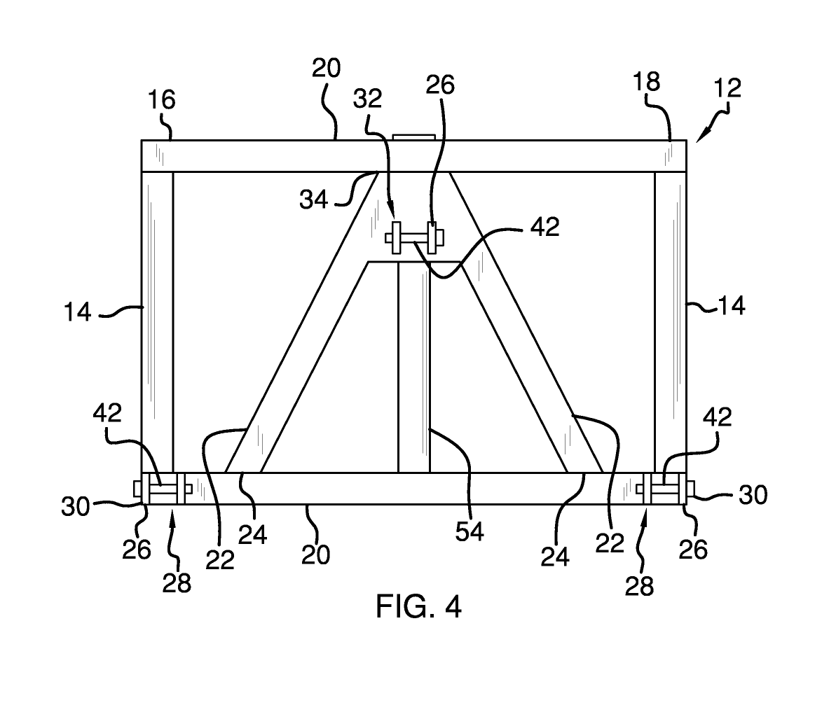

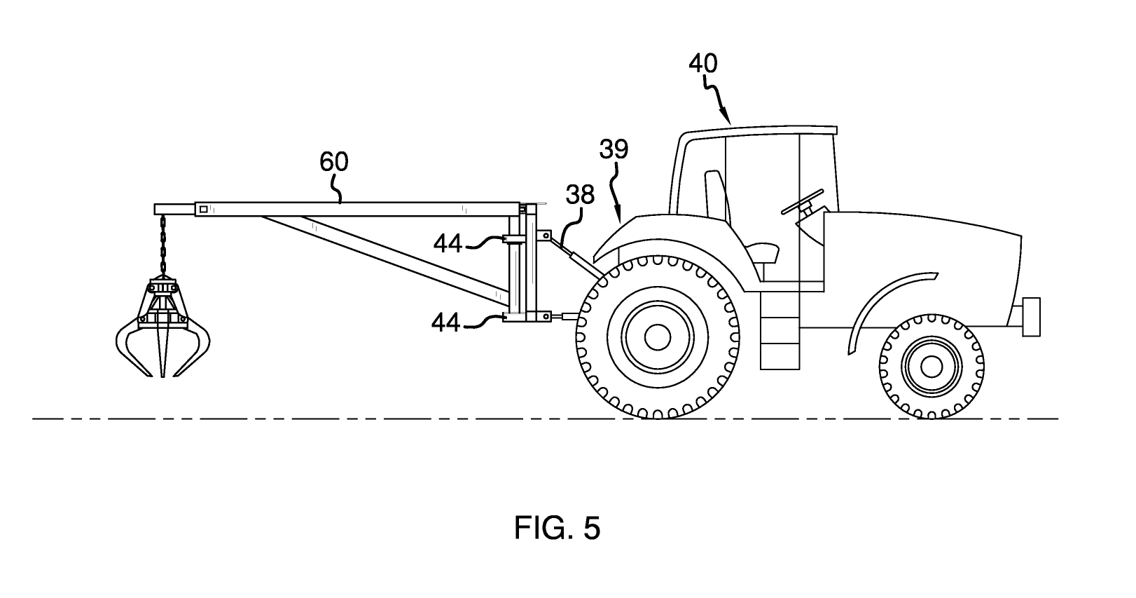

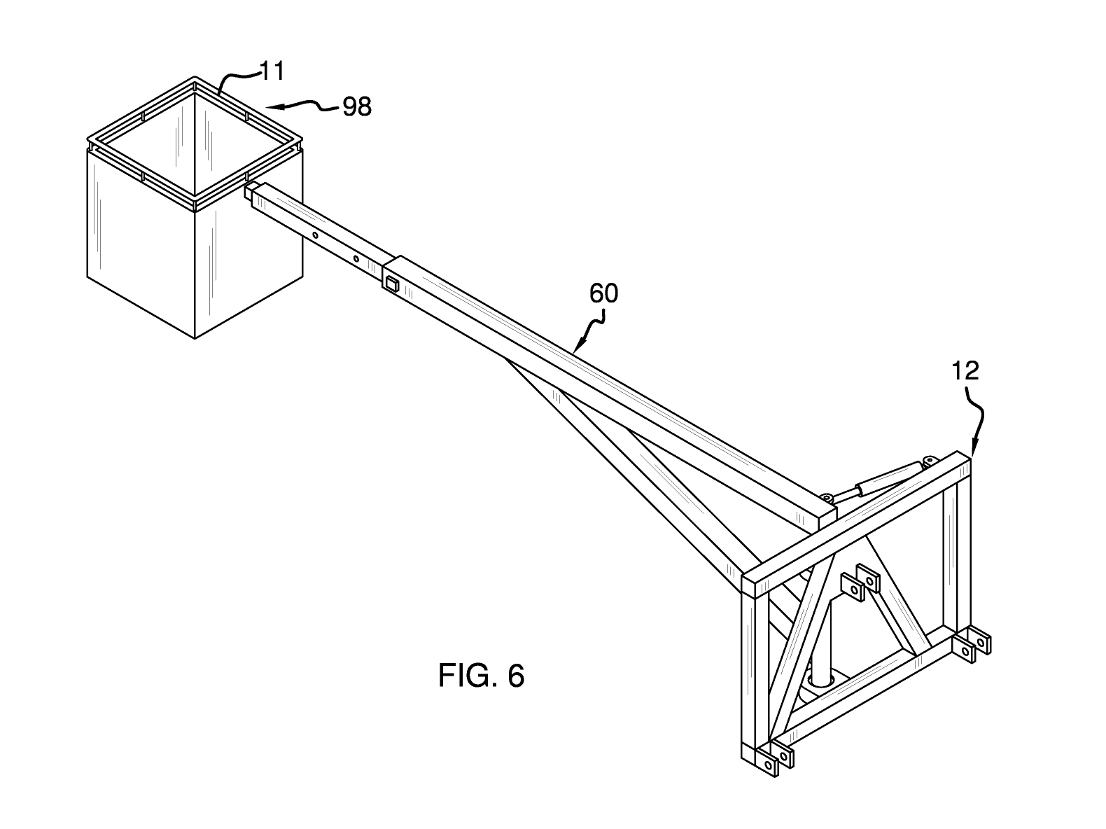

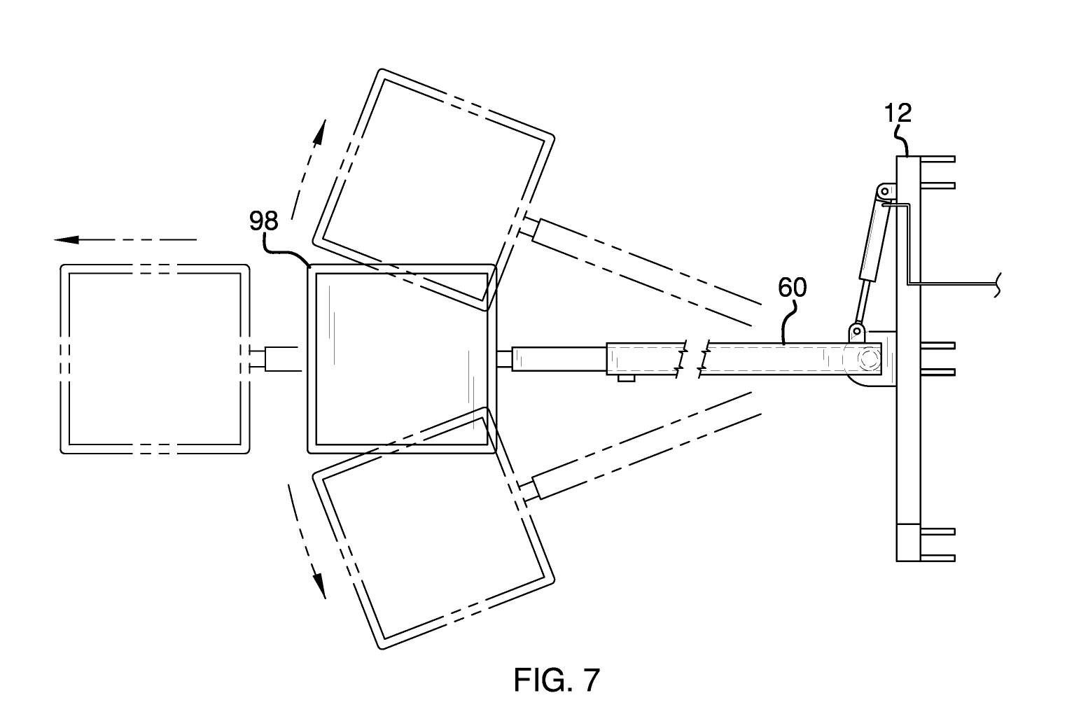

With reference now to the drawings, and in particular to FIGS. 1 through 7 thereof, a new lifting device embodying the principles and concepts of an embodiment of the disclosure and generally designated by the reference numeral 10 will be described.

As best illustrated in FIGS. 1 through 7, the mechanical lifting assembly 10 generally comprises a mount 12. The mount 12 includes a pair of longitudinal arms 14 of the mount 12 each extending between an associated one of a first end 16 and a second end 18 of each of a pair of lateral arms 20 of the mount 12. The mount 12 has a length that is greater than a height of the mount 12. Moreover, the mount 12 has a rectangular shape.

The mount 12 further comprises a pair of support arms 22 each coupled to and extending between the pair of lateral arms 20 of the mount 12. A lowermost end 24 of each of the pair of support arms 22 is spaced apart from each other. The pair of support arms 22 forms a V-shape.

A plurality of couplings 26 is coupled to and extends rearwardly from the mount 12. A bottom pair 28 of the plurality of couplings 26 is each positioned proximate an associated one of a pair of lower corners 30 of the mount 12. A top one 32 of the plurality of couplings 26 is positioned proximate an uppermost end 34 of each of the pair of support arms 22. The plurality of couplings 26 each comprises a pair of plates 36. The pair of plates 36 are each spaced laterally apart.

Each of the plurality of couplings 26 may engage a three point hitch 38 on the rear of a vehicle 40. A plurality of pins 42 extends through an associated one of the plurality of couplings 26. The plurality of pins 42 retains the mount 12 on the vehicle 40. The vehicle 40 may be a tractor of any conventional design.

A pair of receivers 44 is coupled to and extends forwardly from an associated one of a bottom one 45 of the pair of lateral arms 20 of the mount 12 and the pair of support arms 22 of the mount 12. Each of the pair of receivers 44 has a shaft opening 46 extending through a top side 48 and a bottom side 50 of each of the pair of receivers 44. A pair of bearings 52 is each coupled to an associated one of the pair of receivers 44. Each of the pair of bearings 52 is positioned within the shaft opening 46 in the associated pair of receivers 44. The pair of bearings 52 may each be a friction reducing bearing of any conventional design.

The pair of receivers 44 are centrally positioned on the mount 12. A shaft 54 is provided. The shaft 54 has a top end 56 and a bottom end 58. Each of the top 56 and bottom 58 ends of the shaft 54 is rotatably coupled to an associated one of the pair of receivers 44. The shaft 54 extends through the shaft opening 46 in each of the pair of receivers 44. The pair of bearings 52 retains the shaft 54 in each of the pair of receivers 44.

A swing arm 60 has a coupled end 62 and a free end 64. The swing arm 60 is elongated. The coupled end 62 of the swing arm 60 is coupled to the top end 56 of the shaft 54. Moreover, the swing arm 60 forms a right angle with respect to the shaft 54. The swing arm 60 is positionable at a selected angle with respect to the mount 12. The selected angle may be any angle ranging between a full 180° of rotation with respect to the mount 12.

The swing arm 60 comprises a front portion 66 of the swing arm 60 slidably coupled to a back portion 68 of the swing arm 60. The front portion 66 of the swing arm 60 slides inwardly and outwardly from an open end 70 of the back portion 68 of the swing arm 60. The swing arm 60 has a telescopically adjustable length. A plurality of apertures 72 extends laterally through the front portion 66 of the swing arm 60. The plurality of apertures 72 is evenly spaced apart and distributed along an entire length of the front portion 66 of the swing arm 60.

A pin 74 extends laterally through the back portion 68 of the swing arm 60 proximate the open end 70 of the back portion 68 of the swing arm 60. The pin 74 extends through a selected one of the plurality of apertures 72 in the front portion 66 of the swing arm 60. The pin 74 retains the front portion 66 of the swing arm 60 at a selected length with respect to the back portion 68 of the swing arm 60.

A piston 76 is provided. The piston 76 has a primary end 78 and a secondary end 80. The primary end 78 of the piston 76 is coupled to a top one 82 of the pair of lateral arms 20 of the mount 12. The secondary end 80 of the piston 76 is coupled to the swing arm 60 proximate the coupled end 62 of the swing arm 60. The piston 76 urges the swing arm 60 to position the swing arm 60 at the selected angle with respect to the mount 12. Additionally, the piston 76 may be a hydraulic piston of any conventional design. The piston 76 is fluidly coupled to the vehicle's hydraulic system 84.

An auxiliary arm 86 has a leading end 88 and a following end 90. The auxiliary arm 86 is elongated. The leading end 88 of the auxiliary arm 86 is coupled to the shaft 54 proximate the bottom end 58 of the shaft 54. The following end 90 of the auxiliary arm 86 is coupled to a bottom side 92 of the swing arm 60. The auxiliary arm 86 supports the swing arm 60 on the shaft 54. Additionally, the auxiliary arm 86 allows the swing arm 60 to support a load.

A jaw 94 is provided. The jaw 94 is movably coupled to and extends downwardly from the free end 64 of the swing arm 60. The jaw 94 engages an object 96. Moreover, the object 96 is movable when the piston 76 urges the swing arm 60. The object 96 may be a poultry housing unit. The jaw 94 may be a hydraulic grabbing jaw of any conventional design. Alternatively, a box 98 may be coupled to the free end 64 of the swing arm 60. The box 98 has an open top end 11.

In use, the three point hitch 38 on the vehicle 40 moves the swing arm 60 upwardly and downwardly. The jaw 94 engages the object 96. The three point hitch 38 is used to lift the object 96 upwardly. The piston 76 urges the swing arm 60 laterally on the mount 12. The object 96 is moved away to allow access to the spot the object 96 was resting.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mechanical lifting assembly configured to be coupled to a vehicle such that said lifting assembly is extendable rearwardly from the vehicle, said assembly comprising:
a mount coupled to the vehicle;
a swing arm movably coupled to said mount such that said swing arm extends rearwardly from the vehicle, said swing arm being positionable at a selected angle with respect to said mount;
a piston coupled between said mount and said swing arm, said piston urging said swing arm to position said swing arm at the selected angle with respect to said mount; and
a jaw coupled to a distal end of said swing arm with respect to said mount, said jaw engaging an object such that the object is movable when said piston urges said swing arm.

2. The assembly according to claim 1, further comprising said mount comprising a pair of longitudinal arms of said mount each extending between an associated one of a first end and a second end of each of a pair of lateral arms of said mount.

3. The assembly according to claim 1, further comprising said mount further comprising a pair of support arms each coupled to and extending between a pair of lateral arms of said mount.

4. The assembly according to claim 1, further comprising a pair of receivers coupled to and extending forwardly from an associated one of a bottom one of a pair of lateral arms of said mount and a support arm of said mount.

5. The assembly according to claim 1, further comprising a shaft having a top end and a bottom end, each of said top and bottom ends of said shaft being rotatably coupled to an associated one of a pair of receivers.

6. The assembly according to claim 1, further comprising said swing arm having a coupled end and a free end, said swing arm being elongated.

7. The assembly according to claim 1, further comprising a coupled end of said swing arm being coupled to a top end of a shaft such that said swing arm forms a right angle with respect to said shaft.

8. The assembly according to claim 1, further comprising said swing arm comprising a front portion of said swing arm slidably coupled to a back portion of said swing arm such that said swing arm has a telescopically adjustable length.

9. The assembly according to claim 1, further comprising said piston having a primary end and a secondary end.

10. The assembly according to claim 1, further comprising a primary end of said piston being coupled to a top one of a pair of lateral arms of said mount.

11. The assembly according to claim 1, further comprising a secondary end of said piston being coupled to said swing arm proximate a coupled end of said swing arm.

12. The assembly according to claim 1, further comprising an auxiliary arm having a leading end and a following end, said auxiliary arm being elongated.

13. The assembly according to claim 1, further comprising a leading end of an auxiliary arm being coupled to a shaft proximate a bottom end of said shaft.

14. The assembly according to claim 1, further comprising a following end of an auxiliary arm being coupled to a bottom side of said swing arm such that said auxiliary arm supports said swing arm on said shaft.

15. The assembly according to claim 1, further comprising said jaw being coupled to a free end of said swing arm.

16. A mechanical lifting assembly configured to be coupled to a vehicle such that said lifting assembly is extendable rearwardly from the vehicle, said assembly comprising:
a mount comprising a pair of longitudinal arms of said mount each extending between an associated one of a first end and a second end of each of a pair of lateral arms of said mount, said mount further comprising a pair of support arms each coupled to and extending between said pair of lateral arms of said mount, said mount being coupled to the vehicle;
a pair of receivers coupled to and extending forwardly from an associated one of a bottom one of said pair of lateral arms of said mount and said support arm of said mount;
a shaft having a top end and a bottom end, each of said top and bottom ends of said shaft being rotatably coupled to an associated one of said pair of receivers;
a swing arm having a coupled end and a free end, said swing arm being elongated, said coupled end of said swing arm being coupled to said top end of said shaft such that said swing arm forms a right angle with respect to said shaft, said swing arm being positionable at a selected angle with respect to said mount;
said swing arm comprising a front portion of said swing arm slidably coupled to a back portion of said swing arm such that said swing arm has a telescopically adjustable length;
a piston having a primary end and a secondary end, said primary end of said piston being coupled to a top one of said pair of lateral arms of said mount, said secondary end of said piston being coupled to said swing arm proximate said coupled end of said swing arm, said piston urging said swing arm to position said swing arm at the selected angle with respect to said mount;
an auxiliary arm having a leading end and a following end, said auxiliary arm being elongated, said leading end of an auxiliary arm being coupled to said shaft proximate said bottom end of said shaft, said following end of said auxiliary arm being coupled to a bottom side of said swing arm such that said auxiliary arm supports said swing arm on said shaft; and
a jaw coupled to said free end of said swing arm; said jaw engaging an object such that the object is movable when said piston urges said swing arm.
